(19) United States
(12) Patent Application Publication
(10) Pub. No.: US 2026/0330906 A1
(43) Pub. Date: Oct. 22, 2026

(54) REMOTE-CONTROL ACTUATOR

(71) Applicant: TRUSTY CARS LTD., Singapore (SG)

(72) Inventor: Mingtai CHEN, Singapore (SG)

(73) Assignee: TRUSTY CARS LTD., Singapore (SG)

(21) Appl. No.: 19/107,595

(22) PCT Filed: Aug. 29, 2022
(86) PCT No.: PCT/SG2022/050618

§ 371 Date: Feb. 28, 2025

(51) Int. Cl. G07C 9/00; G05G 7/10

(52) U.S. Cl. CPC G07C 9/00944; G05G 7/10; G07C 2009/00952; G07C 2009/00984

(57) ABSTRACT

A remote-control actuator for receiving and actuating a remote-control therein is disclosed. The remote-control actuator includes a controller for receiving at least one control signal. The remote-control actuator further includes a frame, a first arm and a second arm pivotably hinged to the frame and extending in a first direction. The remote-control also includes an actuator that is operable by the controller upon receipt of the at least one control signal to individually tilt the first arm and the second arm to depress a first button and a second button of the remote-control respectively.

### TECHNICAL FIELD

This invention relates to a remote-control actuator. More particularly, this invention relates to a remote-control actuator for actuating remote controls of different designs and dimensions.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Remote controls are used in many applications such as opening and closing of car doors, gates, garage doors, etc. Remote controls used for opening and closing car doors are also known as key fobs. Each key fob has a number of buttons which can be depressed for locking car doors, unlocking car doors, sounding a car alarm, opening a trunk, etc.

Remote controls are usually not shared. Take for example an apartment building with a gate that can be opened or closed using a remote control. The residents living in the apartment building will typically each carry a remote control to be able to go in and out of the apartment block. However, smart phones are ubiquitous these days. A solution is therefore to use the smart phones to operate one single remote control that is placed in a proximity of the gate. To do this, a remote-control actuator that is able to receive wireless command signals from the smart phones or similar devices and actuate corresponding buttons on the remote control is typically employed.

One such remote-control actuator is disclosed in U.S. Pat. No. 9,576,414, Tieman, entitled “Remote Control Button Actuator with Removable Tray.” Tieman discloses an actuation system that is used to actuate one or more buttons on a remote control device, such as a key fob of a vehicle, based upon commands generated from a mobile device, such as a smartphone. A controller receives the command signals from the mobile device and converts the command signals into position commands that are used to activate a button actuator to move a plunger into alignment with one of the buttons on the key fob. The button actuator moves the plunger into contact with one of the buttons which generates a corresponding RF signal from the key fob. The button actuator includes a button actuator tip that is configurable to actuate the buttons on a remote control. The button actuator tip can be moved to any position over the surface of the remote control by actuating first and second servo motors operably linked to a boom to control the boom rotation angle and boom extension distance. Once positioned over a remote control button, the button actuator tip, operably linked to a third servo motor, may be lowered to press a remote control button. The servo motors may be controlled by a programmable controller that receives signals from a mobile device via wireless signals. Such a button actuator has a complicated design and is therefore expensive.

Another system which has a simpler design is disclosed in US Patent Application No. 2009/00108989A1, Sinclair, entitled “Personal Access Arrangement for a Vehicle”. Sinclair discloses a system to permit access of a motor vehicle (100). The vehicle has a key actuatable to enable operation of the vehicle. The system includes a proximity detection arrangement associable with the vehicle and adapted for detection and reading of an electronic tag carried or worn by a driver of the vehicle. A control arrangement is responsive to detection by the proximity detection arrangement of the electronic tag to allow access into the vehicle. In the system, the key is securely mounted upon a plate or substrate. The plate or substrate may be part of a plastic box or like housing which is desirably mounted at a convenient location within the motor vehicle. The key is secured to the substrate using several straps each secured to the substrate using a pair of screws. Also configured upon the substrate is a control and solenoid drive unit. This unit is driven by a detector module. In this fashion, a user of the motor vehicle may approach the motor vehicle whilst wearing the electronic tag and by which the presence of the electronic tag is detected by the detector module. The detector module can thereby output one or more control signals to the control and solenoid drive unit which is operable to interpret the signals received from the tag detector module and to provide drive signals to a pair of micro-solenoids. The micro-solenoids are each positionable above a corresponding one of the buttons of the key. Each of the micro-solenoids is supported by a pivotable rigid support such that a solenoid piston of the corresponding micro-solenoid is normally positioned immediately above the corresponding switch. When an actuation signal is received from the control and solenoid drive unit, the micro-solenoid is able to actuate, extending the piston to contact the button and thereby cause the key to perform the appropriate locking (or unlocking) action, as the case may be. Each of the mounting portions for the corresponding micro-solenoid is able to be pivotally adjusted so that the micro-solenoid can swing away from a position above the corresponding key button. The micro-solenoid can be moved to a non-operative “swing away” position which may be used to provide for in placement, and possible removal, of the key from under the strap restraints. The micro-solenoid should be configured to exert sufficient force upon the corresponding button so as to cause actuation of the button. The supports accordingly must be of sufficient strength so that they may be moved from the pivotal non-operative position into the operative position and yet securely support the micro-solenoid above the key so that sufficient force may be applied downwardly upon the button. Each micro-solenoid can therefore be moved only in a fixed arcuate path. Modifications, such as relocation of the pivotable rigid support, is likely required if a different key is used.

Yet another actuator system is disclosed in U.S. Pat. No. 11,340,649B2, Tieman, entitled “Two button remote control actuator”. The disclosed actuator system includes a pair of actuator arms that are each mounted to a top edge of a pair of spaced side walls of a drawer. Each of the actuator arms is mounted to an actuator clip. Each actuator clip can slide along the top edge to adjust the position of the actuator arm. The outer end of each actuator arm includes an actuator tip. Each actuator arm includes an extension portion slidably mounted relative to a fixed portion. The extension portion can slide along the longitudinal length of the fixed portion to vary the distance the outer end extends relative to the side wall.

A button actuator is positioned over the drawer once each of the pair of actuator arms is positioned and adjusted as described above. The button actuator includes a servo motor that includes a motor shaft. The motor shaft is connected to a linking bracket through a shaft extension. The servo motor is operable to rotate the motor shaft in either a clockwise direction or a counterclockwise direction. The motor shaft is connected to the linking bracket through the shaft extension such that the linking bracket can also rotate in either direction upon actuation of the servo motor.

The linking bracket is securely mounted at a first end to an end of a first actuator rod and at a second end to a second actuator rod. The shaft extension extends through the linking bracket. Opposite ends of the first actuator rod and second actuator rod are received within a second linking bracket. The two linking brackets thus provide a stable and secure support for each of the pair of actuator rods. The first actuator rod is positioned above the left actuator arm while the second actuator arm 154 is positioned above the right actuator arm.

To depress the first button of the key fob, the servo motor operates to rotate the drive shaft in the counterclockwise direction. Such rotation causes the linking bracket to rotate and the actuator rod to move downward and into contact with the left actuator arm. Such movement causes the actuator arm to pivot relative to the stationary clip, causing the actuator tip to depress the first button.

To carry out depression of the second button, the servo motor rotates the motor shaft in the clockwise direction, causing movement of the linking bracket. Such movement causes the actuator rod positioned above the right actuator arm to contact the actuator arm, resulting in pivoting movement of the actuator arm relative to the stationary clip. During this movement, the actuator tip depresses the second button.

Such an actuator system is however only able to actuate key fobs having buttons on a top surface thereof; it is not possible for the actuator system to actuate buttons that are located on a side surface of the key fob without major modifications. There is therefore a need for a remote-control actuator which addresses, at least in part, one or more of the forgoing problems.

### SUMMARY

According to an aspect of the present disclosure, there is provided a remote-control actuator for actuating a remote-control therein. The remote-control actuator includes a controller for receiving at least one control signal. The remote-control actuator further includes a frame, a first arm and a second arm pivotably hinged to the frame and extending in a first direction. The remote-control actuator also includes an actuator that is operable by the controller upon receipt of the at least one control signal to individually tilt the first arm and the second arm to depress a first button and a second button of the remote-control respectively.

In some embodiments, the first arm and the second arm are arms of a first pair of arms pivotably hinged to the frame about a first axis or a second pair of arms pivotably hinged to the frame about a second axis, wherein the second axis is transverse to the first axis. In these embodiments, the actuator is configurable to individually tilt the first pair of arms or the second pair of arms.

In some embodiments, each arm of the first pair of arms and the second pair of arms includes one or more laterally extending portions. The one or more laterally extending portions of each pair of arms are interspersed such that they are aligned along a third axis.

In some embodiments, the actuator is a motor that is operable to tilt the first arm by pulling it via a first cord and tilt the second arm by pulling it via a second cord.

In some embodiments, the server motor includes a servo motor.

In some embodiments, the controller is configured to determine if a current of the servo motor has reached a predetermined threshold value.

In some embodiments, the remote-control actuator further includes a double groove pulley fixedly attached to a shaft of the motor. The double groove pulley has a first groove and a second groove adjacent the first groove. The first cord is wound in a first direction in the first groove and the second cord is wound in a second direction opposite to the first direction in the second groove.

In some embodiments, the first cord and the second cord are releasably attached to the first arm and the second arm respectively.

In some embodiments, each cord is releasably attached to a depression in the first surface of the respective arm using a reclosable fastener.

In some embodiments, each of the first arm and the second arm has a slit at an end thereof through which the respective cord is threaded through for pulling the arm.

In some embodiments, the remote-control actuator further includes a stud releasably attached to each of the first arm and the second arm for actuating the button of the remote-control.

In some embodiments, the stud is releasably attached to the respective arm using a reclosable fastener.

In some embodiments, the remote-control actuator further includes a housing for receiving the frame. The housing having a slot through which the position of the frame within the housing may be adjusted.

In some embodiments, the at least one control signal comprises a wireless data signal.

In some embodiments, the wireless data signal is one of a Bluetooth, a Bluetooth Low Energy (BLE), a Zigbee, a Wi-fi, and a Short Messaging Service (SMS) data signal.

Other aspects and advantages of the invention will become apparent from the following detailed description, taken in conjunction with the accompanying drawings, illustrating by way of example the principles of the invention.

### BRIEF DESCRIPTION OF DRAWINGS

The invention will be better understood with reference to the drawings, in which:

FIG. 1 is an isometric drawing of a remote-control actuator according to an embodiment of the invention, the remote-control actuator including a first pair of arms and a second pair of arms;

FIG. 2 is an isometric drawing of the remote-control actuator in FIG. 1 as viewed in the direction of arrow A in FIG. 1 with studs positioned on the second pair of arms for actuating buttons located on a top surface of a remote control shown in FIG. 4;

FIG. 3 is an isometric drawing of the remote-control actuator in FIG. 1 as viewed in the direction of arrow B in FIG. 1;

FIG. 4 is an isometric drawing of a remote-control with two buttons located on a top surface thereof that are actuatable using the remote-control actuator in FIG. 2;

FIG. 5 is an isometric drawing of a remote-control with two buttons located on a side surface thereof that are actuatable using the remote-control actuator in FIG. 6;

FIG. 6 is an isometric drawing of the remote-control actuator in FIG. 1 showing actuation of one of the first pair of arms thereof for pressing against one of the two buttons of the remote-control in FIG. 5;

FIG. 7 is a plan view of the remote-control actuator in FIG. 6;

FIG. 8 is an isometric view of the remote-control actuator in FIG. 1 shown placed in a housing with the remote control in FIG. 4 also disposed therein; and

FIG. 9 is an isometric view of the housing in FIG. 8 as seen in the direction of arrow C in FIG. 8.

### DETAILED DESCRIPTION OF THE EMBODIMENTS

Throughout this document, unless otherwise indicated to the contrary, the terms “comprising”, “consisting of”, “having” and the like, are to be construed as non-exhaustive, or in other words, as meaning “including, but not limited to.”

Furthermore, throughout the specification, unless the context requires otherwise, the word “include” or variations such as “includes” or “including” will be understood to imply the inclusion of a stated integer or group of integers but not the exclusion of any other integer or group of integers.

Throughout the description, it is to be appreciated that the term ‘controller’ and its plural form include microcontrollers, microprocessors, programmable integrated circuit chips such as application specific integrated circuit chip (ASIC), computer servers, electronic devices, and/or combination thereof capable of processing one or more input electronic signals to produce one or more output electronic signals. The controller includes one or more input modules and one or more output modules for processing of electronic signals.

Unless defined otherwise, all technical and scientific terms used herein have the same meaning as is commonly understood by a skilled person to which the subject matter herein belongs.

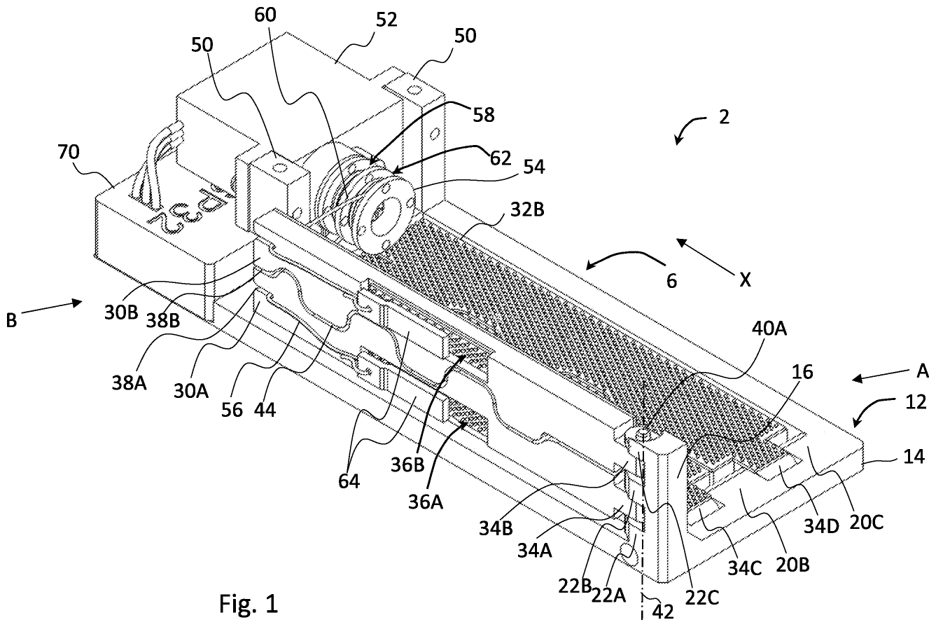

As shown in the drawings for purposes of illustration, the invention may be embodied in a novel remote-control actuator suitable for use with remote controls of different designs and dimensions. Existing remote-control actuators tend to be complicated to make, use and modify. Referring to FIGS. 1-3, a remote-control actuator for actuating a remote control therein embodying the invention generally includes a controller for receiving at least one control signal, a frame, a first arm and a second arm pivotably hinged to the frame and extending in a first direction, and an actuator that is operable by the controller upon receipt of the at least one control signal to individually tilt the first arm and the second arm to depress a first button and a second button of the remote-control respectively.

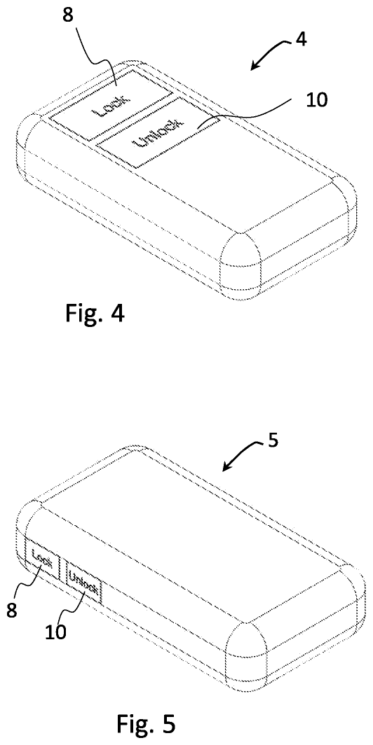

Specifically, FIGS. 1-3 show the above remote-control actuator 2 for actuating a remote-control, such as a first key fob 4 (FIG. 4) or a second key fob 5 (FIG. 5), that is disposed in a remote-control receiving area 6 of the remote-control actuator 2. Each of the first key fob 4 and key fob 5 includes one or more buttons 8, 10 that can be individually depressed to send wireless command signals to a vehicle, e.g., a car (not shown). As an example, the buttons 8, 10 can be pressed to lock the car doors, unlock the car doors, start the engine, open the trunk, send a panic signal, turn on headlamps or perform other functions depending upon the configuration of the key fobs 4, 5.

It should be understood that various other configurations of the key fobs 4, 5 are contemplated as being within the scope of the present disclosure. Although two specific configurations of key fobs are shown in FIGS. 4 and 5, key fobs that can be used with the remote-control actuator 2 may be of different designs and/or dimensions having a different number of buttons.

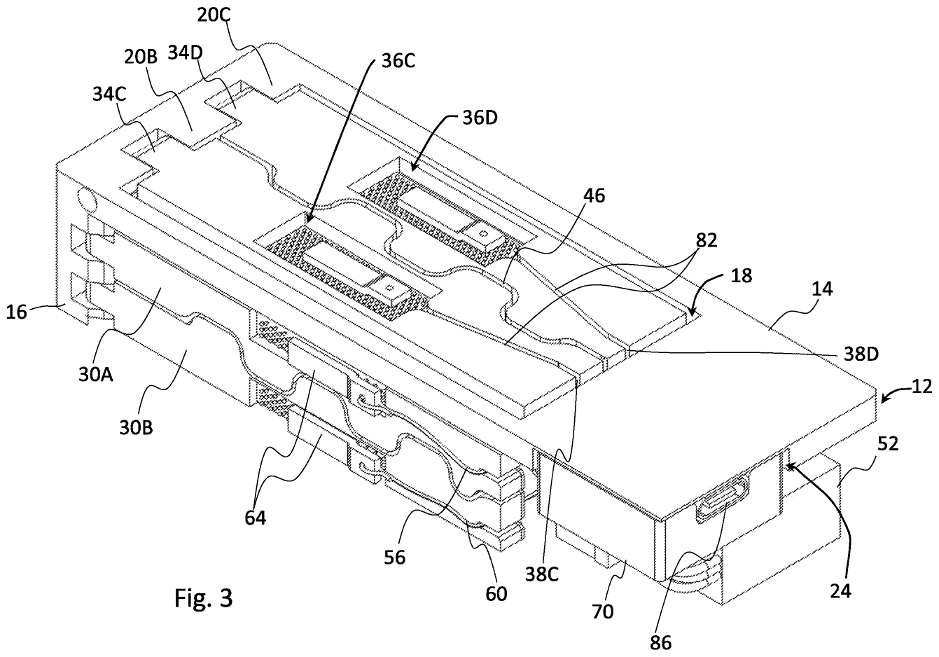

The remote-control actuator 2 includes a frame 12. The frame 12 includes a base 14 and a column 16 extending from a corner of the base 14. The base 14 has an opening 18 (FIG. 3) defined therethrough. Three spaced apart knuckles 20A-20C are defined in a distal end of the base 14 where the column 16 extends from. The three knuckles 20A-20C extend in a first direction, as shown by an arrow X in FIG. 1, into the opening 18 in the base 14. A slot is thus defined between each pair of adjacent knuckles 20A-20C. Similarly, the column 16 includes three spaced apart knuckles 22A-22C which also extend in the first direction. Each pair of adjacent knuckles 22A-22C also define a slot therebetween. A rectangular-shape depression 24 (FIG. 3) is defined in a side of the base 14 where the column 16 is located.

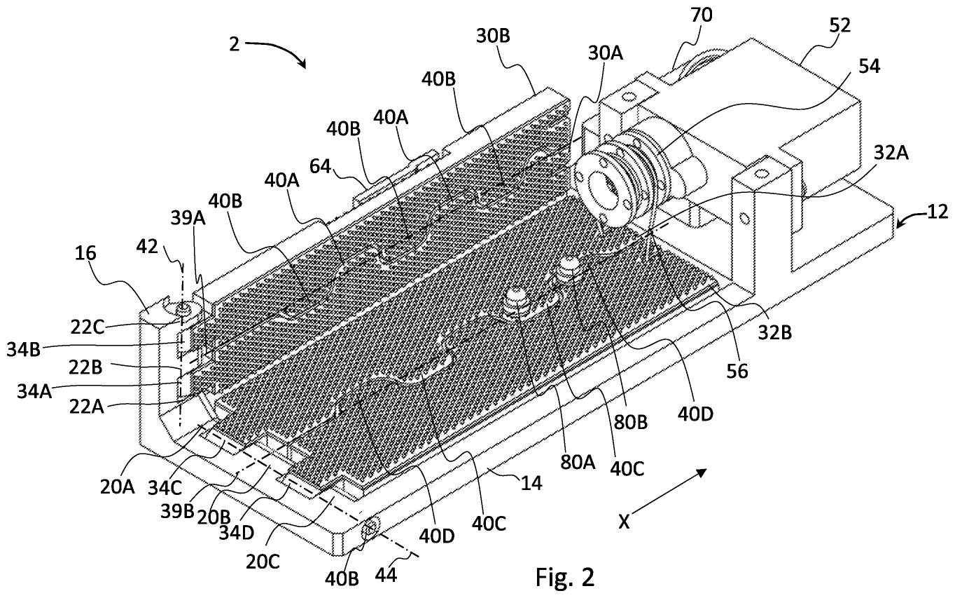

The remote-control actuator 2 further includes two pairs of arms, a first pair of arms 30A, 30B and a second pair of arms 32A, 32B. Each of the first pair and second pair of arms 30A, 30B, 32A, 32B, includes a knuckle 34A-34D at a first end thereof. Each arm 30A, 30B, 32A, 32B, also includes a depression 36A-36D on an outer surface of a medial section of the arm 30A, 30B, 32A, 32B. Disposed in the depression 36A-36D of each arm 30A, 30B, 32A, 32B, is a reclosable fastener. Suitable reclosable fasteners include, but are not limited to, hook and loop fasteners from Velcro Companies (United Kingdom), and Dual Lock fasteners from 3M Company (Minnesota, United States). Each arm 30A, 30B, 32A, 32B further includes a slit 38A-38D at a second end thereof. Each arm 30A, 30B, 32A, 32B also includes multiple laterally extending portions 40A-40D. The laterally extending portions 40A-40D of each pair of arms 30A, 30B, 32A, 32B extend in opposite directions and are located on each arm 30A, 30B, 32A, 32B such that when mounted to the frame 12 they are interspersed to be aligned along an axis 39A, 39B (FIG. 2). The inner surface of each arm 30A, 30B, 32A, 32B, facing the remote control receiving area 6, is covered with any suitable disclosable fastener, such as but not limited to, those described above.

The first pair of arms 30A, 30B includes a lower arm 30A proximal to the base 14 and an upper arm 30B distal from the base 14. The knuckle 34A of the lower arm 30A fits into a lower slot between a first pair of knuckles 22A, 22B of the column 16. The knuckle 34B of the upper arm 30B fits into an upper slot between a second pair of knuckles 22B, 22C of the column 16. An elongated pin or bolt 40A is inserted through holes (not shown) in the knuckles 22A-22C, 34A, 34B of the lower arm 30A, the upper arm 30B and the column 16. In this manner, the lower arm 30A and the upper arm 30B are supported by and pivotably hinged to the column 14 of the frame 12 to be individually tiltable about a first axis 42. Each arm 30A, 30B is tiltable between a non-operative position over the side of the base 14 away from the remote-control receiving area 6 and an actuated position away from the side of the base 14 into the remote-control receiving area 6. When so mounted, the lower arm 30A and the upper arm 30B are spaced apart to be separated by a small gap 44 so that the movement of one arm 30A, 30B is not impeded by the other arm 30B, 30A. Each of the lower arm 30A and the upper arm 30B is of a first width of about 7.7 mm although other widths are also possible.

The second pair of arms 32A, 32B includes an inner arm 32A proximal to the column 16 and an outer arm 32B distal from the column 16. The knuckle 34C of the inner arm 32A fits into an inner slot between a first pair of knuckles 20A, 20B of the base 14 proximal to the column 16. The knuckle 34D of the outer arm 32B fits into an outer slot between a second pair of knuckles 20B, 20C of the base 14 distal from the column 16. An elongated pin or bolt 40B is inserted through holes (not shown) in the knuckles 20A-20C, 34C, 34D of the inner arm 32A, the outer arm 32B and the base 14. In this manner, the inner arm 32A and the outer arm 32B are pivotably hinged to the base 14 of the frame 12 to be individually tiltable about a second axis 44. Each arm 32A, 32B is tiltable between a non-operative position in the opening 18 in the base 14 and an actuated position away from the opening 18 of the base 14 in the remote-control receiving area 6. The second axis 44 is transverse to the first axis 42. In this specific embodiment, the second axis 44 is orthogonal to the first axis 42. In other words, the first pair of arms 30A, 30B and the second pair of arms 32A, 32B lie on different planes that are orthogonal to each other. Likewise, the inner arm 32A and the upper arm 32B are separated by a gap 46 to be spaced apart so that movement of one arm 32A, 32B is not impeded by the other arm 32B, 32A. The inner arm 32A and the outer arm 32B each has a second width larger than the first width of about 15.1 mm although other widths are also possible.

Extending from the base 14 distal from the column 16 are two supporting columns 50. The remote-control actuator 2 includes an actuator, such as a servo motor 52. The servo motor 52 is fixedly mounted between the two supporting columns 50 such that a shaft (not shown) of the servo motor 52 is extending over the second ends of the second pair of arms 32A, 32B. In this position, the shaft is also laterally adjacent the second ends of the first pair of arms 30A, 30B. Fixedly attached to the shaft of the servo motor 52 is a double groove pulley 54. A first cord 56 is wound around a groove 58 of the pulley 54 proximal to the server motor 52 in a clockwise direction as viewed in the direction of the arrow X. A second cord 60 is wound around a distal groove 62 of the pulley 54 distal from the server motor 52 in an anti-clockwise direction as viewed in the direction of the arrow X. A piece of reclosable fastener 64 is attached to a free end of each cord 56, 60. The first cord 56 is threaded through the slit 38A in the second end of a first arm 30A, 32B, across the outer surface of the first arm 30A, 32B for the reclosable fastener 64 to be releasably attached to the reclosable fastener in the depression 36A, 36D of the first arm 30A, 32B. The first arm can either be the lower arm 30A of the first pair of arms 30A, 30B or the outer arm 32B of the second pair of arms 32A, 32B. In this non-actuated position of the servo motor 52, the first cord 56 is kept taut and the first arm 30A, 32B is in its non-operative position away from the remote-control receiving area 6. In the same manner, the second cord 60 is threaded through the slit 38B in the second end of a second arm 30B, 32A, across the outer surface of the second arm 30B, 32A for the reclosable fastener 64 to be releasably attached to the recloseable fastener in the depression 36B, 36C of the second arm 30B, 32A. The second arm may be the upper arm 30B of the first pair of arms 30A, 30B or the inner arm 32A of the second pair of arms 32A, 32B. In this non-actuated position of the servo motor 52, the second cord 60 is kept taut and the second arm 30B, 32A is in its non-operative position away from the remote-control receiving area 6. Each cord 56, 58 may be any suitable cord, such as but not limited to, a multi-strand steel cable, a nylon cord, or a cord of any material that is flexible and sufficiently durable.

The remote-control actuator 2 further includes a controller module 70. The controller module 70 is seated in the depression 24 in the base 14 below the servo motor 52. The controller module 70 includes a controller (not shown) therein. The controller is able to receive one or more wireless data signals associated with actuation of the buttons 8, 10 of the key fob 4, 5. Accordingly, the wireless data signals may include wireless data signals for instructing the remote-control actuator 2 to lock the car doors, unlock the car doors, start the engine, open the trunk, send a panic signal, turn on headlamps, etc. In the embodiment shown in FIG. 1, only two buttons of the key fob 4, 5 are actuatable. Those skilled in the art would recognize that key fobs can have from two to as many as eight buttons in any type of layout and orientation on up to three surface planes of the remote control. The key fobs also come in a variety of package sizes and designs. The remote-control actuator 2 shown in FIG. 1 can be configured to actuate any two buttons of any of these key fobs.

Any known wireless communication protocols may be used to send the wireless data signals to the remote-control actuator 2. These wireless communication protocols include, but are not limited to, Bluetooth, Bluetooth Low Energy (BLE), Zigbee, Wi-fi, and Short Messaging Service (SMS) protocols. The use of SMS would extend the range of operation of the remote-control actuator 2 as compared to the other short range wireless communication protocols. In this manner, smart phones can be used to send SMS messages to the remote-control actuator 2 to control its operation. As an example, the controller may be configured to receive a first SMS message including a first predefined alpha-numeric message to unlock the car doors and a second SMS message including a second predefined alpha-numeric message to lock the car doors. When receiving an SMS message, the controller compares the alpha-numeric message therein with predefined messages stored thereon. Only when there is a match will the controller actuate the servo motor 52 to depress a corresponding button 8, 10 of the key fob 4, 5.

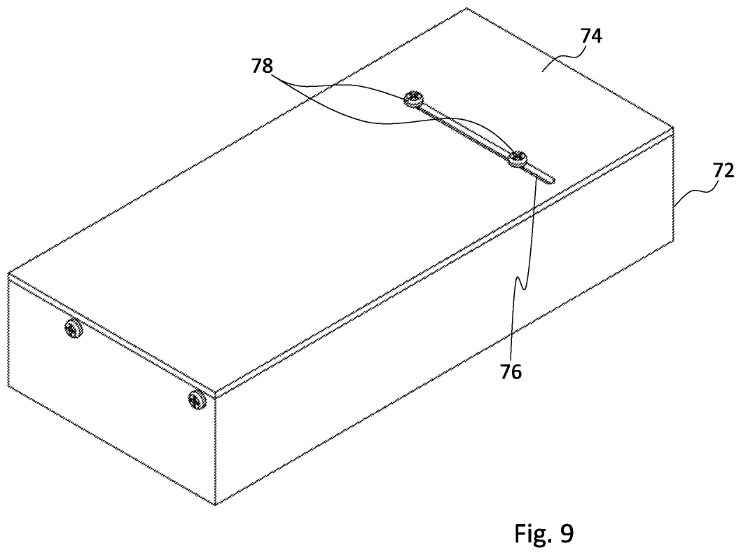

The frame 12 together with the assembled parts is mounted in a housing 72 having a base 74 as shown in FIGS. 8 and 9. The base 74 has an elongated slot 76 therethrough. This slot 76 allows the position of the frame 12 within the housing to be adjusted. Two screws 78 are screwed onto the base 14 of the frame 12 through the slot 76. The two screws 78 are loosened to allow the frame 12 to be slideable along the length of the slot 76. The screws 78 can be tightened to secure the frame 12 to the base 74 of the housing 72. The housing 72 further includes a cover (not shown).

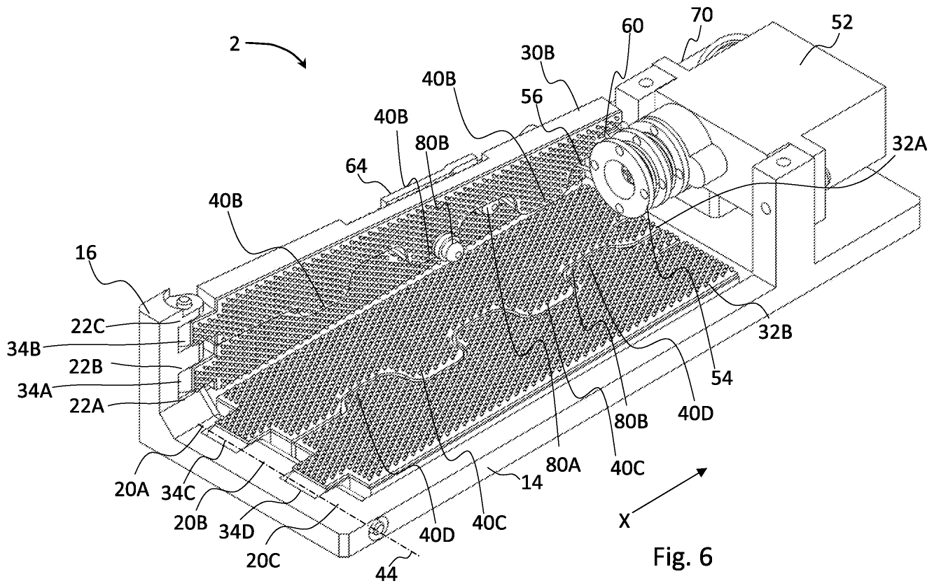

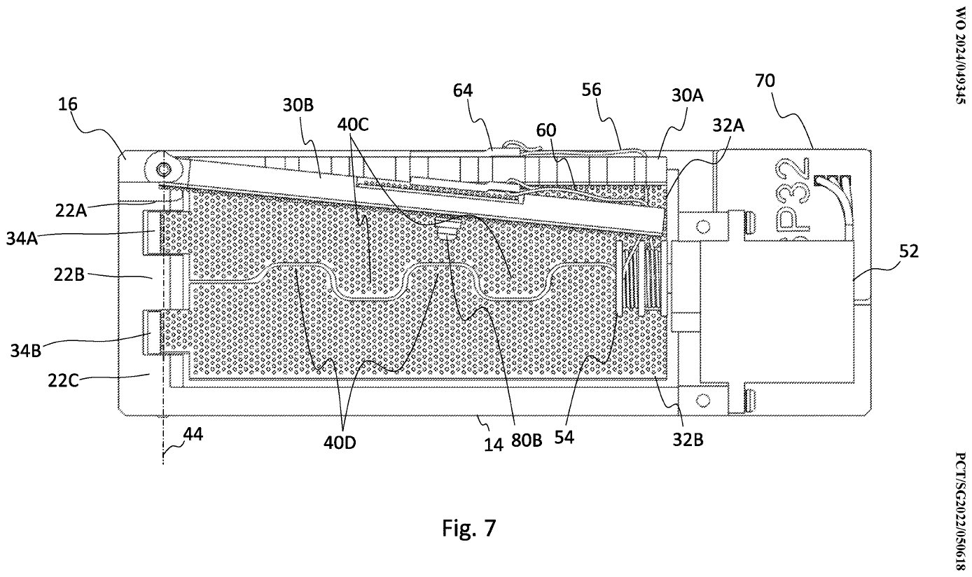

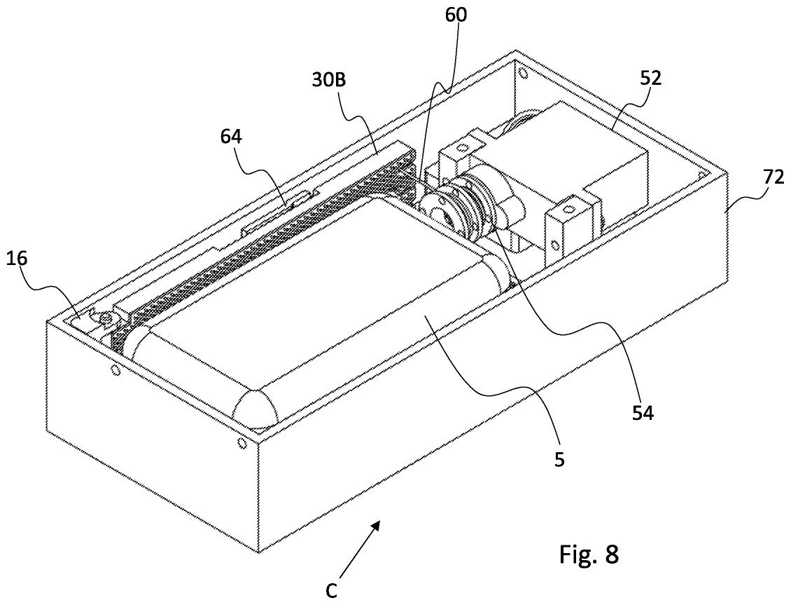

During use of the remote-control actuator 2 to depress an unlock button 10 and a lock button 8 located on a side of a key fob 5 shown in FIG. 5, the key fob 5 is securely mounted to the second pair of arms 32A, 32B. A reclosable fastener (not shown) is adhered to an undersurface of the key fob 5. The key fob 5 is aligned in the remote-control receiving area 6 such that the unlock button 10 is directly opposite a laterally extending portion 40B of the upper arm 30B and the lock button 8 is directly opposite a laterally extending portion 40A of the lower arm 30A. The key fob 5 is then pressed against the second pair of arms 32A, 32B to allow the reclosable fasteners on the pair of arms 32A, 32B and the key fob 5 to mate to securely hold the key fob 5 in place against the pair of arms 32A, 32B. As shown in FIG. 6, a removable stud 80A, 80B is attached to each laterally extending portion 40A, 40B for depressing a corresponding button of the key fob 5.

When the controller receives the wireless data signal for unlocking doors, it actuates the servo motor 52 to depress the unlock button 10 of the key fob 5. To do this, the servo motor 52 is operated to rotate the shaft in the clockwise direction as viewed in the direction of the arrow X in FIG. 6. Such rotation of the servo motor 52 reels in the second cord 60 to pull the upper arm 30B towards the key fob 5 in the remote-control receiving area 6. As the servo motor 52 continues to rotate in the clockwise direction, the stud 80B on the upper arm 30B will engage and depress the unlock button 10. When this happens, current drawn by the servo motor 52 increases as rotation of the servo motor 52 is impeded. The controller monitors the current drawn and stops the servo motor 52 momentarily when the current reaches a predetermined threshold value. More specifically, the servo motor 52 is stopped for a period that is longer than the debouncing period of the unlock button 10, typically in the range of several tens of milliseconds. When the servo motor 52 rotates in the clockwise direction, the first cord 56 is reeled out so that it slackens, and the lower arm 30A is thus not actuated. After the unlock button 10 has been depressed, the controller reverses the servo motor 52 to rotate it in the anti-clockwise direction. The second cord 60 that is reeled in earlier is now reeled out and force is no longer applied to the upper arm 30B. Resilience in the unlock button 10 is thus able to push the upper arm away to return it to its non-operative position. Biasing of the upper arm 30B is thus unnecessary.

Similarly, when the controller receives the wireless data signal for locking doors, it can actuate the servo motor 52 to depress the lock button 8 of the key fob 5. To do this, the servo motor 52 is operated to rotate the shaft in the anti-clockwise direction as seen in the direction of the arrow X in FIG. 6. Such rotation of the servo motor 52 reels in the first cord 56 to pull the lower arm 30A towards the key fob 5. As the servo motor 52 continues to rotate in the anti-clockwise direction, the stud 80A attached thereto engages and depresses the lock button 8. When this happens, current drawn by the servo motor increases as rotation of the servo motor 52 becomes impeded. The controller monitors the current and stops the servo motor momentarily when the current reaches the threshold value. When the servo motor 52 rotates in this anti-clockwise direction, the second cord 60 is reeled out and the upper arm 30B is not actuated. In this manner, the lower and upper arms 30A, 30B may be individually actuated using only a single servo motor 52. One button is actuatable when the servo motor 52 is operated in one direction and the other button is actuatabe when the servo motor 52 is operated in the opposite direction.

To actuate the lock and unlock buttons 8, 10 located on a top surface of the key fob 4 shown in FIG. 4, the key fob 4 is securely mounted to the cover of the housing 72 with the buttons facing downwards away from the cover. The free ends of the cords 56, 60 are attached to the second pair of arms, i.e., the inner arm 32A and the outer arm 32B. The undersurface of each of the second pair of arms include a groove 82 (FIG. 3) leading from the slit 38C, 38D to the depression 36C, 36D. Each cord 56, 60 is threaded in these grooves 82 so that they do not protrude from the undersurface of the arms 32A, 32B. As described earlier, the key fob 4 is mounted such that the laterally extending portion of one of the second pair of arms is directly below the unlock button 10 and the laterally extending portion of the other of the second pair of arms is directly below the lock button 8. For example, the unlock button 10 is directly opposite the laterally extending portion 40C of the inner arm 32A and the lock button 8 is directly opposite the laterally extending portion 40D of the outer arm 32B. Studs 80A, 80B (FIG. 2) are removably attached on these laterally extending portions 40C, 40D for depressing the buttons 8, 10. In this manner the lock and unlock buttons 8, 10 can be individually depressed using a corresponding one of the arms of the second pair of arms 32A, 32B. The manner in which the servo motor 52 is actuated to tilt the inner arm 32A and the outer arm 32B is exactly the same as that described above with regard to the upper arm 30B and lower arm 30A and will thus not be repeated.

The controller and the servo motor 52 may be powered by an external power source (not shown) through a suitable port 86 (FIG. 3) The external power source may include, but is not limited to, a lithium polymer battery pack, a power bank, a solar power source, etc. The port 86 may be a USB-C port as shown in FIG. 3 although any suitable receptacle may be used. It is also contemplated that the controller and the servo motor 52 may also receive power from a 12-volt DC power source, such as a vehicle battery. The controller includes a microcontroller (not shown), such as but not limited to, an ESP32 microcontroller available from Expressif Systems, a company based in Shanghai, China. The controller further includes a 4G module (not shown), such as but not limited to, a SIM 7600E from SIMCom Wireless Solutions Limited. The 4G module is connected to the microcontroller. To conserve power, the microcontroller is put in a sleep/standby mode. When the 4G module receives the above-described SMS, the 4G module will interrupt the microcontroller to bring the microcontroller out of the sleep/standby mode to obtain the alpha-numeric message from the 4G module. The microcontroller is further coupled to the servo motor 52 to actuate it.

Advantageously, the above-described remote-control actuator 2 is of a simple singular design. It has wireless connectivity with mobile devices for actuating a single remote control stored therein. It may simply be used as a standalone device located within a vehicle without any modification to the vehicle's electronic, electrical or mechanical system. The remote-control actuator 2 can also cater to remote controls of different designs and/or dimensions without requiring any modification. All that is required is to attach the cords to either the first pair or the second pair of arms and to position the studs depending on where buttons are located on a remote control. The remote-control actuator is also rather compact.

Although the present invention is described as implemented in the above described embodiment, it is not to be construed to be limited as such. For example, reclosable fasteners are described as being used to releasably attach one part to another. However, any type of fasteners may be used. In fact, each part that is described as releasably attached may also be fixedly attached. Fasteners that may be used include any suitable type of adhesives and tapes. As another example, each cord may be attached to an arm simply by tying a knot in the cord that is resting against the slit. The knot is of a width that is larger than the width of the slit such that it will not slip through the slit when the cord is pulled.

As another example, each arm is described as including a number of laterally extending portions. In some embodiments, each arm may include just a single laterally extending portion. In other embodiments, it is also possible for only one arm in each pair of arms to include a laterally extending portion that is adjacent a second end of the other arm.

As a further example, the remote-control actuator may include only a single pair of arms instead of the two pairs of arms as described above. The arms of each pair of arms may also be tiltable about different axes.

As yet a further example, any suitable motor may be used, including but not limited to a stepper motor, dc geared motor, and other motors known to those skilled in the art. In other embodiments, other types of actuators may be used. These would include but not limited to solenoids, linear actuators, hydraulic or pneumatic pistons for pushing or pulling the arms.

As another example, the remote-control actuator 2 is also described as being used to actuate a key fob. It should not be construed to be so limited. The remote-control actuator 2 may be used to receive and actuate any type of remote-controls, including but not limited to, remote controls for opening and closing gates and garage doors, remote controls for electronic appliances, such as air-conditioners, fans, lights, etc.

It should be further appreciated by the person skilled in the art that one or more of the above modifications or improvements, not being mutually exclusive, may be further combined to form yet further embodiments of the present invention.

1. A remote-control actuator for actuating a remote-control, the remote-control actuator comprising:
a controller for receiving at least one control signal;
a frame;
a first arm and a second arm pivotably hinged to the frame and extending in a first direction;
an actuator that is operable by the controller upon receipt of the at least one control signal to individually tilt the first arm and the second arm to depress a first button and a second button of the remote-control respectively.

2. The remote-control actuator according to claim 1, wherein the first arm and the second arm are arms of one of a first pair of arms pivotably hinged to the frame about a first axis and a second pair of arms pivotably hinged to the frame about a second axis, wherein the second axis is transverse to the first axis, and wherein the actuator is configurable to individually tilt the arms of one of the first pair of arms and the second pair of arms.

3. The remote-control actuator according to claim 1, wherein each of the first arm and the second arm includes at least one laterally extending portion, wherein the at least one laterally extending portion of the first arm and the second arm are interspersed such that they are aligned along an axis.

4. The remote-control actuator according to claim 1, wherein the actuator is a motor that is operable to tilt the first arm by pulling it via a first cord and tilt the second arm by pulling it via a second cord.

5. The remote-control actuator according to claim 4, wherein the motor comprises a servo motor.

6. The remote-control actuator according to claim 5, wherein the controller is configured to determine if a current of the servo motor has reached a predetermined threshold value.

7. The remote-control actuator according to claim 4, further comprising a double groove pulley fixedly attached to a shaft of the motor, the double groove pulley having a first groove and a second groove adjacent the first groove, wherein the first cord is wound in a first direction in the first groove and the second cord is wound in the second direction opposite to the first direction in the second groove.

8. The remote-control actuator according to claim 4, wherein the first cord and the second cord are releasably attached to the first arm and the second arm respectively.

9. The remote-control actuator according to claim 8, wherein each of the first cord and the second cord is releasably attached to a depression in a first surface of the respective arm.

10. The remote-control actuator according to claim 9, wherein each cord is releasably attached to the depression in the first surface of the respective arm using a reclosable fastener.

11. The remote-control actuator according to claim 10, wherein each of the first arm and the second arm has a slit at an end thereof through which the respective cord is threaded through for pulling the arm.

12. The remote-control actuator according to claim 1, further comprising a stud releasably attached to each of the first arm and the second arm for actuating the button of the remote-control.

13. The remote-control actuator according to claim 12, wherein the stud is releasably attached to the respective arm using a reclosable fastener.

14. The remote-control actuator according to claim 1, further including a housing for receiving the frame, the housing having a slot through which the position of the frame within the housing may be adjusted.

15. The remote-control actuator according to claim 1, wherein the at least one control signal comprises a wireless data signal.

16. The remote-control actuator according to claim 15, wherein the wireless data signal is one of a Bluetooth, a Bluetooth Low Energy (BLE), a Zigbee, a Wi-fi, and a Short Messaging Service (SMS) data signal.
